(19) United States
(12) Patent Application Publication
(10) Pub. No.: US 2017/0251692 A1
(43) Pub. Date: Sep. 7, 2017

(54) Confectionery Containing Low Viscosity Iota Carrageenan

(71) Applicant: FMC Corporation, Philadelphia, PA (US)

(72) Inventors: Nadia Yaranossian, Bruxelles (BE); Maurice Gerard Lynch, Waterloo (BE)

(21) Appl. No.: 15/513,646

(22) PCT Filed: Sep. 24, 2015
(86) PCT No.: PCT/US15/51900

§ 371 Date: Mar. 23, 2017

Related U.S. Application Data
(60) Provisional application No. 62/055,750, filed on Sep. 26, 2014.

(51) Int. Cl. A23G 3/42; A23L 29/231; A23L 29/281; A23L 29/256; A23L 29/206

(52) U.S. Cl. CPC A23G 3/42; A23L 29/256; A23L 29/206; A23L 29/281; A23L 29/231

(57) ABSTRACT

The present invention provides a food product in which gelatins are replaced with a texturizer composition comprising a low viscosity iota carrageenan. The present invention also provides a method for replacing gelatins in a food product with a texturizer composition comprising low viscosity iota carrageenan. In preferred embodiments, the invention provides a gelled confectionery containing a texturizer composition comprising low viscosity iota carrageenan, which allows the partial or full replacement of gelatin in the composition.

### FIELD OF THE INVENTION

The present invention provides a food product in which gelatins are replaced with a texturizer composition comprising a low viscosity iota carrageenan. The present invention also provides a method for replacing gelatins in a food product with a texturizer composition comprising low viscosity iota carrageenan. In preferred embodiments, the invention provides a gelled confectionery containing a texturizer composition comprising low viscosity iota carrageenan, which allows the partial or full replacement of gelatin in the composition. In further preferred embodiments, the production of the gelled confectionery with the low viscosity iota carrageenan-based texturizer may be performed without substantial modification of the production equipment for the gelled confectionery.

### BACKGROUND OF THE INVENTION

Traditionally, gelatin is used in high brix gummy confectionery products as it allows for a low gelling temperature and thus easy depositing of the hot confectionery composition into molds during manufacture. Recent cost increase for gelatin and an increase in demand for vegetarian, kosher and halal products are pushing confectionery manufacturers to find alternative texturizers to gelatin. Although traditional types of carrageenans may provide a desirable texture and can be used for vegetarian, kosher and halal products, they unfortunately present difficulties for application to industrial manufacturing of high brix gummy confectionery products due to their high gelling temperature. U.S. Pat. No. 6,592,926 B2 provides how to prepare a confectionery product comprising a texturizer containing a minimum 50% dosage of an iota carrageenan and resulting in a relatively high setting temperature of above 95° C. The present invention allows lower gelling temperatures, particularly as compared to standard carrageenans, while hot depositing high brix confectionery products during manufacture by using a texturizer composition comprising low viscosity iota carrageenan.

There is a demand for alternatives to gelatin as a texturizer/gelling agent. For many applications, it is difficult to replace gelatin in a confectionery formulations, while maintaining the low deposition temperature and simultaneously preserving the quality of the food product, including properties such as texture, taste and appearance. Typically, gelatin provides a desirable firm and elastic texture when used in gummy-type confectionery products. Where the goal is to change from gelatin as the texturizer/gelling agent to an alternative gelling agent, there exists a substantial challenge in formulating a stable food product which can be deposited at a low temperature and using the same or substantially the same manufacturing equipment.

There remains an unmet need for food grade compositions that can provide the functionality and properties of a gelatin-based texturizer and simultaneously maintaining the quality of the food product, including properties such as taste, texture and appearance.

Carrageenan is a galactan polysaccharide isolated from red seaweed. All carrageenans contain repeating galactose units joined by alternating α1→3 and β1→4 glycosidic linkages and are sulfated to widely varying degrees. The types of carrageenan may be distinguished, in part, by their degree and position of sulfation, as well as the seaweed from which they are obtained. The various types of carrageenan include kappa, kappa-2, iota, lambda, mu and nu. For example, iota carrageenan has a repeating unit of D-galactose-4-sulfate-3,6-anhydro-D-galactose-2-sulfate providing a sulfate ester content of about 25 to 34%. Iota carrageenan can be obtained, for example, from Eucheuma denticulatum (also referred to as “Spinosum”). Kappa carrageenan has a repeating unit of D-galactose-4-sulfate-3,6-anhydro-D-galactose and is obtained, for example, from Kappaphycus alvarezii (also known as “Eucheuma cottonii”).

Because carrageenans vary in their composition and structure, they also vary in properties and uses. Carrageenans also vary in molecular weight, cation content and type. Commercial grades of carrageenans exist as counter ion salt forms, the most common counter ions being calcium, sodium and potassium. Many commercial carrageenans exist as mixed salt forms while others are predominantly of a specific counter ion salt form. The identity of the counter ion composition may influence several properties of the carrageenan including solubility, texture, setting temperature and application properties. Carrageenans with high gelling cation levels have high gelling temperatures. Calcium-ions predominantly interact strongest with iota-carrageenan. U.S. Pat. No. 8,404,289 describes a method to reduce the gelling cations present in the carrageenans. This ion-exchange technology is used to reduce the overall content of the gelling cations resulting in a lower gelling and setting temperature of the carrageenan composition. The removal of these gelling cation ions however may adversely affect the texture of the gummy confectionery product and will not prevent a potential increase in gelling temperature due to the addition of other recipe ingredients used in the confectionery product, such as calcium from sources including hard water and fruit juices or concentrates used as flavoring components. These typically contain high calcium levels. U.S. Pat. No. 7,816,341 disclosed the use of reduced viscosity carrageenans with low concentrations of gelling cations for the production of films having lower gelling temperatures. In contrast, for the present invention it is surprisingly found that the use of low viscosity iota carrageenan with a high content of gelling cations can be used in combination with other hydrocolloids to create a confectionery type of product.

### SUMMARY

The purpose of this invention is to replace gelatin with a texturizer composition comprising low viscosity iota carrageenan in food products, such as high brix confectioneries, by formulating the product with a texturizer according to the present invention. The texturizer compositions of the present invention allow for the reduction or elimination in the amount of gelatin in food products. The demand for an alternative to gelatin has created a technological need in the food manufacturing industry. Gelatin-based gummies can be processed at a temperature below about 90 degrees. However, due to the differences in gelling temperature it is difficult to replace gelatin with carrageenans, while achieving equivalent processing parameters and maintaining the food product stability, texture and appearance. Additionally, the texturizer composition allows for the creation of additional and alternative textures in confectionery products. The present invention allows lower gelling temperature while hot depositing of high brix confectionery using a low viscosity iota type carrageenan.

The texturizer composition of the present invention comprising a low viscosity iota carrageenan provides a gelled texture to the finished confectionery product while allowing the composition to be deposited at temperature lower than about 90° C. during manufacture. By using an iota type carrageenan with low viscosity it is possible to easily process a high brix confectionery product. Accordingly, the manufacturer of the confectionery products preferably does not have the need to make any particular capital investment for plant modifications when switching from gelatin-based texturizers to the texturizer compositions of the present invention.

In preferred embodiments, the present invention is directed to a confectionery composition comprising (i) a texturizer including a low viscosity iota carrageenan and an additional hydrocolloid; and (ii) a sweetener, wherein the low viscosity iota carrageenan has a viscosity less than about 30 cP when measured in 1.5% concentration at 75° C., and wherein the texturizer provides a gelled texture to the final confectionery product. In particularly preferred embodiments, the confectionery composition is substantially free of gelatin.

In further preferred embodiments, the additional hydrocolloid may be selected from the group consisting of a kappa carrageenan, HM pectin, co-processed cellulose/cellulose gum or a combination of these hydrocolloids. The additional hydrocolloid most preferably includes a kappa carrageenan.

In other preferred embodiments, the present invention is directed to a process for the preparation of a high brix confectionery comprising the step of depositing the confectionery composition at a temperature less than about 90° C., wherein the confectionery composition comprises (i) a texturizer comprising a low viscosity iota carrageenan and an additional hydrocolloid; and (ii) a sweetener; wherein the low viscosity iota carrageenan has a viscosity less than about 30 cP when measured in 1.5% concentration at 75° C.; and wherein the texturizer provides a gelled texture to the final confectionery product.

### DESCRIPTION OF THE DRAWINGS

FIG. 1 shows a graph for the texture profile analysis (TPA) of a gummy candy.

### DETAILED DESCRIPTION

The invention relates to the use of low viscosity iota carrageenan in the texturizer system used in food products, and particularly in a high brix confectionery as an alternative texturizer to gelatin.

The term texturizer as used in the present invention refers to a composition of stabilizers or gelling agents which provide texture, structure and physical stability to a finished food formulation or product. The texturizer gives dimensional stability to the composition by providing a physical network within which components of the confectionery composition are firmly held in place. In preferred embodiments, the texturizer composition of the present invention provides a gelled texture to the confectionery product.

The term “food product” as used herein refers to edible products containing one or more ingredients selected from carbohydrates (e.g., sugars and starches), proteins, dietary fiber, water, and flavoring agents, etc., and which are formulated for human consumption. In preferred embodiments of the present invention, the food product according to the present invention is a high brix gelled confectionery. A gelled confectionery is a gelled product containing a mixture of carbohydrates, mainly sugar, texturizing (or gelling) agents, flavor and color.

The term “high brix” refers to a confectionery product that has a sugar content of the finished product higher than about 70% by weight of the finished product. Degree (°) brix is the content of sugar in the composition, wherein 1° brix refers to 1 gram of sugar per 100 grams of the composition.

Examples of high brix confectionery products that can be prepared according to the present invention include jellies and gums, such as gummy bears, gum drops, jelly beans, fruit snacks, chewy candies, wine gums and the like. The high brix confectionery product includes those confections in which gelling agents are typically present, such as those listed above. In certain embodiments, the texturizer composition of the present invention may also be used as a gelling agent in confections where gelatin is not normally present, but can be added to change the texture and flavor thereof.

In preferred embodiments, the present invention is used to produce gummies based on low viscosity iota carrageenan in the same manufacturing plant design as for the gelatin based-gummy products. This invention allows lower gelling temperature while processing a high brix confectionery product, and while providing a final firm and elastic texture to the finished product.

### Low Viscosity Iota Carrageenan

The texturizer composition of the present invention comprises a low viscosity iota carrageenan. The viscosity of the low viscosity iota carrageenan is preferably from about 10 cP to about 49 cP when measured in 1.5% concentration at 75° C. (see below). In particularly preferred embodiments, the low viscosity carrageenan preferably has a viscosity lower than about 30 cP when measured in 1.5% concentration at 75° C. The low viscosity of this iota carrageenan allows for a lower viscosity of the high brix confectionery during heating and permits deposition of the confectionery composition at a temperature lower than about 90° C.

The low viscosity iota carrageenan used in the present invention typically has a higher content of metal ions than does iota carrageenan that is isolated using the ion-exchange. The low viscosity iota carrageenan used in the compositions of the present invention have different ions levels, generally higher, than ion-exchange iota carrageenans.

Viscosity of the iota carrageenan can be controlled by various methods known to those skilled in the arts. The seaweed raw materials have an inherent range of quality and can be selected and blended to yield the target viscosity upon carrageenan recovery. In addition or alternatively, the control of processing conditions including use of oxidizing agents, reaction time, temperature and pH can modify the viscosity of the carrageenan that is produced.

According to the present invention, the viscosity of the low viscosity iota carrageenan used in this invention is measured in water at 1.5% concentration and at 75° C. with a Brookfield viscometer using a No. 1 LV spindle at 30 rpm. For comparison with ion-exchange iota carrageenan, NaCl (0.58%) is added to the water solution when measuring the viscosity of ion-exchange carrageenan to provide representative values as ion-exchange carrageenan contains very low levels of ions.

The texturizer composition of the present invention may comprise the low viscosity iota carrageenan in an amount of about 50% or less, by weight of the texturizer composition. In preferred embodiments, the low viscosity iota carrageenan is present in the texturizer composition in an amount from about 20% to about 50% by weight, and more preferably from about 40% to about 50% by weight of the texturizer composition. All % by weights provided in this paragraph are on a dry basis and based on the total weight of the texturizer composition.

In preferred embodiments, the texturizer composition used in the present invention comprises the low viscosity iota carrageenan and an additional hydrocolloid. The additional hydrocolloid component may be selected from the group consisting of carboxymethyl cellulose, starches and derivatives thereof, pectins (including high methoxyl (“HM”), low methoxyl pectins, and acetylated pectins (such as beet pectin)), alginate, carrageenans (lambda, kappa, kappa-2, mu, nu, theta, or mixtures thereof), xanthan gum, agar gum, and gellan gum, and mixtures thereof. In preferred embodiments of the invention, the hydrocolloid is kappa carrageenan, HM pectin, co-processed cellulose/cellulose gum or a combination of these hydrocolloids. The additional hydrocolloid is most preferably a kappa carrageenan.

The additional hydrocolloid used in the present invention is typically present in the texturizer composition in an amount above about 35%, and more preferable above about 40%, by weight of the texturizer composition. In preferred embodiments, the additional hydrocolloid is present in the texturizer composition in an amount from about 35% to about 60% by weight, and more preferably from about 40% to about 50% by weight of the texturizer composition. All % by weights provided in this paragraph are on a dry basis and based on the total weight of the texturizer composition.

The texturizer composition is preferably used in the confectionery composition in an amount from about 1.5% up to about 3%, based on the weight of the confectionery composition, and preferably from about 1.8% to about 2.8%, and more preferably from about 2% to about 2.5%.

The confectionery composition may contain a pH regulator which can provide an acidic pH. In preferred embodiments, the pH regulator provides a pH of the confectionery composition in the range of about 2 to about 5, and more preferably in the range of about 3 to about 4.

The confectionery product according to the present invention contains a sweetener. The sweetener may be one sweetener or a mixture of two or more sweeteners. For the high brix confections, the sweetener comprises one or more sugars. The preferred sugars are sucrose, glucose, and fructose, and the most preferred sugars are glucose and sucrose. Sweeteners also include syrups, such as corn syrup and foods such as honey, molasses, maple syrup and the like.

By corn syrup, it is meant a purified concentrated solution of nutritive sugars obtained from starch. There are various types of corn syrup contemplated for use in the confectionery products of the present invention. The acid converted corn syrups are those derived from the acid hydrolysis of starch. Examples of this type corn syrup are glucose syrup, for example, 42 DE glucose syrup, wherein DE refers to dextrose equivalent. In certain embodiments, sugar substitutes and sugar replacements can also be utilized as the sweetening agent.

The confectionery product according to the present invention contains a sweetener, typically glucose and/or sucrose, in an amount of at least about 40% by weight of the confectionery composition. In certain embodiments, it is particularly preferred that the sweetener is present in the confectionary composition in an amount of at least about 70% by weight. It is preferred that the sweetener comprises from about 40% to about 85% by weight in the confection and more preferably from about 45% to about 80% by weight in the confection. In certain particularly preferred embodiments, the sweetener is present in the confectionary composition in an amount of about 70% to about 85% by weight.

The confectionery product according to the present invention may optionally contain additional flavoring agents, coloring agent, preservatives, high-intensity sweeteners and the like.

### Preparation of Gelled Confections

In preferred embodiments of the invention, the high brix confectionery product can be prepared by depositing the hot confectionery composition into a mold. In the preferred embodiments the confectionery composition can be deposited at a temperature less than about 90° C., and preferably at less than about 87° C. For the preferred applications, the low deposition temperature allows the confectionery compositions of the present invention to be processed using the same equipment as the gelatin-based confectionery products.

The traditional gummy bear is made from a mixture of sugar, glucose syrup, starch, flavoring, food coloring, citric acid, and gelatin. This sugar, glucose syrup, and gelling systems are cooked to a brix level of about 75-78° in a cooker. The hot liquid mixture is transferred to a depositing line. Prior to depositing, the flavor, color, acid are injected into the mixture. Depositing is done into starch molds and allowed to cool and set. Once set, the candies can be removed from the molds, enrobed with food wax and packaged.

In certain preferred embodiments of the invention, the confectionery compositions have the components in ranges according to the following table:

TABLE 1

| Ingredients | % |
|---|---|
| Glucose syrup | 45 to 75 |
| 42 or 60DE | |
| Sugar | 14 to 42 |
| Texturizer composition | 2 to 2.5 |
| Tri-Na-Citrate | 0.4 to 0.67 |
| Citric Acid 50% solution | 1.25 to 2 |
| Color | 0.05-0.80 |
| Flavor | 0.10-1.0 |
| Water | 15-35 |
| Brix | 80-81 |
| pH | 3.3-3.5 |

It will be recognized that the weight percents of the ingredients in the confectionery composition of the invention may be adjusted accordingly to attain the desired results, such as texture, taste, mouthfeel, etc. Such routine adjustment of the composition is fully within the capabilities of one having skill in the art and is within the scope and intent of the present invention.

### EXAMPLES

In order to describe the invention in more detail, the following non-limiting examples are provided.

The low viscosity iota carrageenan and kappa carrageenans used in the following Example 2-7 are listed below:

TABLE 2

| | | | | | Viscosity | |
|---|---|---|---|---|---|---|
| Material | K⁺ | Ca⁺⁺ | Mg⁺⁺ | Na⁺ | (cP) | seaweed source |
| iota carrageenan | 6.20 | 0.73 | 0.51 | 2.79 | 22 | eucheuma spinosum |
| kappa carrageenan A | 5.00 | 2.70 | 0.18 | 0.65 | 28 | eucheuma cottonii |
| kappa carrageenan B | 3.50 | 0.20 | 0.10 | 4.50 | 8.1 | eucheuma cottonii |

### Viscosity Procedure:

The viscosity of the carrageenans reported in the Examples was determined according to the following protocol:
1.1 Tare a 600 ml beaker with a three-bladed stirrer. Add 400-450 ml distilled or demineralized water.
1.2 To prepare the 1.5% carrageenan solution, weigh 7.50 g of the sample to be tested and disperse in the water with sufficient agitation.
1.3 Continue agitation until sample is evenly dispersed. Bring weight in the beaker to 500 g net weight.
1.4 Heat in a boiling water bath with continued agitation until a temperature of 80 to 82° C. is reached.
1.5 Remove from the boiling water bath and bring back to weight with distilled or demineralized water.
1.6 Cool to 76-77° C. with continuous hand agitation. At the same time, temper the spindle and guard or UL adapter in hot water and wipe dry.
1.7 Read viscosity using Brookfield viscometer set at 30 rpm with a No. 1 LV spindle.
1.8 Take reading after viscometer equilibrates (around 6 revolutions at 30 rpm). By this time, temperature of the solution will be close to 75° C.
   Texture Profile Analysis Measurement Using TA-XT2 Plus from SMS

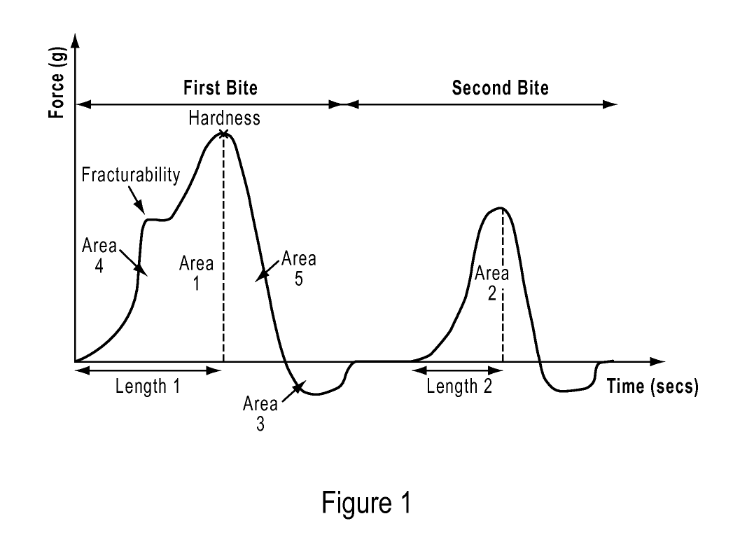

Texture profile analysis (TPA) is an objective method of sensory analysis. The test consists of compressing a bite-size piece of food two times in a reciprocating motion that imitates the action of chewing. From the resulting force-time curve a number of textural parameters are extracted that correlate well with sensory evaluation of those parameters. A typical TPA profile of gummy candy is provided by in FIG. 1. Table 3 provides the calculation of certain texture parameters with reference to the TPA, such as provided in FIG. 1.

TABLE 3
Calculation of the texture parameters

| Parameter | Calculation |
|---|---|
| Hardness | Maximum peak force |
| Springiness | Length 2/Length 1 |
| Cohesiveness | Area 2/Area 1 |
| Resilience | Area 5/Area 4 |
| Gumminess | Hardness × Cohesiveness × Springiness |

Settings of the TPA test method:
Probe: P/75 mm plate SS
Pretest speed: 5 mm/s
Test speed: 5 mm/s
Posttest speed: 5 mm/s
Distance: 5 mm

### pH Measurement of Gummies

The pH of the gummies prepared according to the following Examples was measured according to the following protocol:
1. Place 5 g of chopped finished product in 100 ml of water.
2. Heat for 5 minutes at 350 Watts in microwave until the chopped gummy melts.
3. Measure the pH of this solution.

### Example 1—Comparative Gelatin Gummy

A standard gelatin gummy bear was prepared according to the recipe provided in Table 1.1.

TABLE 1.1

| | Recipe for gelatin gummy candies |
|---|---|
| Ingredients | % |
| Glucose syrup 60DE | 75 |
| Sugar | 15 |
| Gelatin (250 bloom) | 6 |
| Tri-Na-Citrate | 0.3 |
| Citric Acid 50% solution | 1.25 |
| FMC Red P2359 | 0.38 |
| Flavor strawberry Givaudan | 0.25 |
| 78712-36 | |
| Water | 20 |
| Total | 110.18 |
| Depositing with funnel at 86-87° C. | Possible low viscosity, |
| | easy to deposit |
| Properties of finished gummy | Firm and elastic texture |
| samples | |
| Brix | 81 |
| pH | 3.17 |

Texture of gummy bears
Texture analyzer, TPA test

| | |
|---|---|
| Hardness (g) | 798.78 |
| Springiness | 1.088 |
| Cohesiveness | 0.654 |
| Gumminess | 676.4 |
| Resilience | 0.301 |

The gelatin-based gummies were prepared according to the following steps:
1. Prepare dried molding starch in white trays with bear prints and preheat the funnel in a 90° C. water bath.
2. Add gelatin to cold water and leave it to swell for about 20 minutes.
3. Put this solution in the 90° C. water bath until completely dissolved.
4. Cook the glucose syrup and sugar to 116° C.
5. Cool to 100° C. and then add the gelatin solution. Mix well at low agitation.
6. Add flavor, color, tri-Na-citrate and acid while mixing at low agitation.
7. Deposit with funnel into molding starch and cover with a layer of starch
8. Store at room temperature for 2 to 4 hours, and store at 45° C. for 2-3 days.
9. Remove gummies from starch and enrobe with waxy oil.

The gelatin based gummies produced according to this procedure were evaluated and the characteristics are reported in Table 1.1.

### Example 2

A texturizer composition was prepared using low viscosity iota carrageenan having a viscosity of 22 cP according to Table 2.1:

TABLE 2.1

| ingredient | % |
|---|---|
| iota carrageenan | 50 |
| kappa carrageenan A | 44 |
| Sugar | 6 |
| Total | 100 |

The texturizer prepared according to Table 2.1 was used in the preparation of carrageenan-based gummies at 2% to 2.5% according to Table 2.2:

TABLE 2.2

| | Sample 2a | Sample 2b |
|---|---|---|
| Recipe ingredients | % | % |
| Glucose syrup 60DE | 75 | 75 |
| Sugar | 15 | 15 |
| Texturizer from 2.1 | 2 | 2.5 |
| Tri-Na-Citrate | 0.4 | 0.4 |
| Citric Acid 50% soln | 1.25 | 1.25 |
| Color: FMC Red P2359 | 0.38 | 0.38 |
| Flavor: strawberry Givaudan | 0.25 | 0.25 |
| 78712-36 | | |
| Water | 20 | 20 |
| Total | 114.28 | 114.78 |
| | Possible, easy to | Possible, easy to |
| Depositing with funnel at | deposit | deposit |
| 86-87° C. | | |
| Properties of finished | Firm and elastic | Firm and elastic |
| gummy sample | texture | texture |
| Brix | 81 | 80 |
| pH | 3.47 | 3.43 |

Texture of gummy bears
Texture analyzer, TPA test

| | | |
|---|---|---|
| Hardness (g) | 432.39 | 569.86 |
| Springiness | 6.03 | 5.37 |
| Cohesiveness | 0.859 | 0.874 |
| Gumminess | 371.15 | 497.93 |
| Resilience | 0.530 | 0.623 |

The gummies were prepared according to the following procedure:
1. Prepare dried molding starch in white trays with bear prints and preheat the funnel in a 90° C. water bath.
2. Prepare a mix of glucose syrup and water and heat until 60-70° C.
3. Prepare a dry mix of the stabilizer and tri-Na-Citrate with sugar or hydrocolloid. Add this dry mix to the glucose syrup water mix.
4. Boil to desired solids (maximum 75-77° Brix).
5. Add flavor, color and acid.
6. Deposit with funnel into molding starch and cover with a layer of starch.
7. Store at room temperature for 2 to 4 hours and then store at 45° C. in molding starch for 2-3 day.
8. Remove gummies from starch and enrobe with waxy oil.

The gummies prepared according to this procedure were evaluated and the results are reported in Table 2.2.

### Example 3

A texturizer composition was prepared using low viscosity iota carrageenan having a viscosity of 22 cP according to Table 3.1:

TABLE 3.1

| ingredient | % |
|---|---|
| Iota carrageenan | 50 |
| Kappa carrageenan A | 44 |
| Avicel GP 7210 (MCC, CMC) | 6 |
| Total | 100 |

The texturizer prepared according to Table 3.1 was used in the preparation of gummies according to Table 3.2. The texturizer is used at 2% to 2.5%. The gummies were prepared according to the process steps reported in Example 2. The resulting gummies were evaluated and the results are also reported in Table 3.2.

TABLE 3.2

| | Sample 3a | Sample 3b |
|---|---|---|
| Ingredients | % | % |
| Glucose syrup 60DE | 75 | 75 |
| Sugar | 15 | 15 |
| Texturizer from 3.1 | 2 | 2.5 |
| Tri-Na-Citrate | 0.4 | 0.4 |
| Citric Acid 50% soln | 1.25 | 1.25 |
| FMC Red P2359 | 0.38 | 0.38 |
| Flavor strawberry Givaudan | 0.25 | 0.25 |
| 78712-36 | | |
| Water | 20 | 20 |
| Total | 114.28 | 114.78 |
| | Possible, easy to | Possible, easy to |
| Depositing with funnel at | deposit | deposit |
| 86-87° C. | | |
| Properties of finished | Firm and elastic | Firm and elastic |
| gummy sample | texture | texture |
| Brix | 81 | 81 |
| pH | 3.41 | 3.42 |

Texture of gummy bears
Texture analyzer, TPA test

| | | |
|---|---|---|
| Hardness (g) | 460.29 | 553.15 |
| Springiness | 6.20 | 4.36 |
| Cohesiveness | 0.856 | 0.870 |
| Gumminess | 393.85 | 481.09 |
| Resilience | 0.552 | 0.582 |

### Example 4

A texturizer composition was prepared using low viscosity iota carrageenan having a viscosity of 22 cP according to Table 4.1:

TABLE 4.1

| ingredient | % |
|---|---|
| Iota carrageenan | 50 |
| kappa carrageenan B | 44 |
| Sugar | 6 |
| Total | 100 |

The texturizer prepared according to Table 4.1 was used in the preparation of carrageenan-based gummies according to Table 4.2. The gummies were prepared according to the process steps reported in Example 2. The resulting gummies were evaluated and the results are also reported in Table 4.2. A comparison of the data from Table 2.2 and Table 4.2 shows that a change from kappa carrageenan A to kappa carrageenan B can provide more texture to the gummies

TABLE 4.2

| | Sample 4 |
|---|---|
| Ingredients | % |
| Glucose syrup 60DE | 75 |
| Sugar | 15 |
| Texturizer from 4.1 | 2 |
| Tri-Na-Citrate | 0.4 |
| Citric Acid 50% soln | 1.25 |
| FMC Red P2359 | 0.38 |
| Flavor strawberry Givaudan | 0.25 |
| 78712-36 | |
| Water | 20 |
| Total | 114.28 |
| Depositing with funnel at | Possible, easy to deposit |
| 86-87° C. | |
| Properties of finished | Firm and elastic texture |
| gummy sample | |
| Brix | 81 |
| pH | 3.42 |

Texture of gummy bears
Texture analyzer, TPA test

| | |
|---|---|
| Hardness (g) | 641.77 |
| Springiness | 5.16 |
| Cohesiveness | 0.861 |
| Gumminess | 552.48 |
| Resilience | 0.589 |

### Example 5

A texturizer composition was prepared using low viscosity iota carrageenan having a viscosity of 22 cP according to Table 5.1:

TABLE 5.1

| ingredients | % |
|---|---|
| iota carrageenan | 50 |
| kappa carrageenan A | 44 |
| Sugar | 6 |
| Total | 100 |

Using the process of Example 2, carrageenan-based gummies were prepared using the texturizer according to Table 5.1 and using the recipe reported in Table 5.2, which used alternative glucose syrup/sugar compositions. The resulting gummies were evaluated and the results are also reported in Table 5.2.

TABLE 5.2

| | Sample 5a | Sample 5b |
|---|---|---|
| Ingredients | % | % |
| Glucose syrup 42DE | 45 | — |
| Glucose syrup 60DE | — | 45 |
| Sugar | 42 | 42 |
| Texturizer from 5.1 | 2.5 | 2.5 |
| Tri-Na-Citrate | 0.3 | 0.3 |
| Citric Acid 50% soln | 1.25 | 1.25 |
| FMC Red P2359 | 0.38 | 0.38 |
| Flavor strawberry Givaudan | 0.25 | 0.25 |
| 78712-36 | | |
| Water | 20 | 20 |
| Total | 111.68 | 111.68 |
| | Possible, easy to | Possible, easy to |
| Depositing with funnel at | deposit | deposit |
| 86-87° C. | | |
| Properties of finished | Firm and elastic | Firm and elastic |
| gummy sample | texture | texture |
| Brix | 80 | 80 |
| pH | 3.15 | 3.19 |

Texture of gummy bears
Texture analyzer, TPA test

| | | |
|---|---|---|
| Hardness (g) | 806.163 | 734.450 |
| Springiness | 0.994 | 0.756 |
| Cohesiveness | 0.759 | 0.546 |
| Gumminess | 611.698 | 587.200 |
| Resilience | 0.435 | 0.406 |

### Example 6

A texturizer composition was prepared using low viscosity iota carrageenan having a viscosity of 22 cP according to Table 6.1:

TABLE 6.1

| ingredient | % |
|---|---|
| Iota carrageenan | 50 |
| Kappa carrageenan A | 44 |
| Avicel GP 7210 (MCC, CMC) | 6 |
| Total | 100 |

Using the process of Example 2, gummies were prepared using the texturizer according to Table 6.1 and using the recipe reported in Table 6.2. The resulting gummies were evaluated and the results are also reported in Table 6.2 which used alternative glucose syrup/sugar compositions.

TABLE 6.2

| | Sample 6a | Sample 6b |
|---|---|---|
| Ingredients | % | % |
| Glucose syrup 42DE | 45 | — |
| Glucose syrup 60DE | — | 45 |
| Sugar | 42 | 42 |
| Texturizer from 6.1 | 2.5 | 2.5 |
| Tri-Na-Citrate | 0.3 | 0.3 |
| Citric Acid 50% soln | 1.25 | 1.25 |
| FMC Red P2359 | 0.38 | 0.38 |
| Flavor strawberry Givaudan | 0.25 | 0.25 |
| 78712-36 | | |
| Water | 20 | 20 |
| Total | 111.68 | 111.68 |
| Depositing with funnel at | Possible, easy to | Possible, easy to |
| 86-87° C. | deposit | deposit |
| Properties of finished | Firm and elastic | Firm and elastic |
| gummy sample | texture | texture |
| Brix | 81 | 80 |
| pH | 3.22 | 3.18 |

Texture of gummy bears
Texture analyzer, TPA test

| | | |
|---|---|---|
| Hardness (g) | 728.340 | 878.282 |
| Springiness | 0.834 | 1.537 |
| Cohesiveness | 0.576 | 0.750 |
| Gumminess | 562.450 | 658.237 |
| Resilience | 0.403 | 0.417 |

### Example 7

A texturizer composition was prepared using low viscosity iota carrageenan having a viscosity of 22 cP according to Table 7.1:

TABLE 7.1

| ingredient | % |
|---|---|
| Iota carrageenan | 55 |
| Kappa carrageenan A | 35 |
| Sugar | 10 |
| Total | 100 |

The texturizer prepared according to Table 7.1 was used in the preparation of carrageenan based gummies according to Table 7.2. The texturizer is used at 2.5% illustrating that the depositing temperature needs to be increased to 90° C., during depositing a lot of tailing is visible (tailing is happening when viscosity of the hot mixture is too high) the final texture of the gummy candies is firm and elastic.

TABLE 7.2

| | Sample 7 |
|---|---|
| Recipe ingredients | % |
| Glucose syrup 60DE | 75 |
| Sugar | 15 |
| Texturizer from 7.1 | 2.5 |
| Tri-Na-Citrate | 0.4 |
| Citric Acid 50% soln | 1.25 |
| Color: FMC Red P2359 | 0.38 |
| Flavor: strawberry Givaudan | 0.25 |
| 78712-36 | |
| Water | 20 |
| Total | 114.78 |
| | Possible to deposit at 90° C. |
| Depositing with funnel at | but very long tailing. |
| 86-87° C. | |
| Properties of finished | Firm and elastic |
| gummy sample | texture |
| Brix | 81 |
| pH | 3.4 |

Texture of gummy bears
Texture analyzer, TPA test

| | |
|---|---|
| Hardness (g) | 727.60 |
| Springiness | 0.97 |
| Cohesiveness | 0.812 |
| Gumminess | 587.40 |
| Resilience | 0.387 |

### Example 8

A texturizer composition was prepared using standard viscosity iota carrageenan having a viscosity of 71 cP according to Table 8.1:

TABLE 8.1

| ingredient | % |
|---|---|
| iota carrageenan | 72 |
| kappa carrageenan B | 18 |
| Sugar | 10 |
| Total | 100 |

The texturizer prepared according to Table 8.1 was used in the preparation of carrageenan based gummies according to Table 8.2. The texturizer is used at 2.5% illustrating the depositing is not possible below 90° C., although final texture is firm and elastic.

TABLE 8.2

| | Sample 8 |
|---|---|
| Recipe ingredients | % |
| Glucose syrup 60DE | 75 |
| Sugar | 15 |
| Texturizer from 8.1 | 2.5 |
| Tri-Na-Citrate | 0.67 |
| Citric Acid 50% soln | 2 |
| Color: FMC Red P2359 | 0.38 |
| Flavor: strawberry Givaudan | 0.25 |
| 78712-36 | |
| Water | 20 |
| Total | 115.8 |
| | Not possible to deposit |
| | below 90° C. Depositing at |
| Depositing with funnel at | 95° C. but very long tailing. |
| 86-87° C. | |
| Properties of finished | Firm and elastic texture |
| gummy sample | |
| Brix | 81 |
| pH | 3.53 |

Texture of gummy bears
Texture analyzer, TPA test

| | |
|---|---|
| Hardness (g) | 382.42 |
| Springiness | 8.96 |
| Cohesiveness | 0.937 |
| Gumminess | 359.321 |
| Resilience | 0.652 |

We claim:

1. A confectionery composition comprising:
a texturizer comprising a low viscosity iota carrageenan and an additional hydrocolloid; and
a sweetener;
wherein the low viscosity iota carrageenan has a viscosity less than about 30 cP when measured in 1.5% concentration at 75° C.;
and wherein the texturizer provides a gelled texture to the final confectionery product.

2. The confectionery composition of claim 1, wherein the composition is substantially free of gelatin.

3. The confectionery composition of claim 1 or 2, wherein the additional hydrocolloid is selected from the group consisting of kappa carrageenan, HM pectin, co-processed cellulose/cellulose gum or a combination of these hydrocolloids.

4. The confectionery composition of claim 3, wherein the additional hydrocolloid is kappa carrageenan.

5. The confectionery composition of claims 1 to 4, wherein the texturizer is present in the confectionery composition in an amount of from about 1.5% to about 3% by weight of the confectionery composition.

6. The confectionery composition of claim 5, wherein the texturizer comprises the low viscosity iota carrageenan in an amount of about 50% or less, by weight of the texturizer composition.

7. The confectionery composition of claim 6, wherein the additional hydrocolloid is present in the texturizer composition in an amount above about 35%, by weight of the texturizer composition.

8. The confectionery composition of claims 1 to 7, wherein the sweetener comprises one or more sugars.

9. The confectionery composition of claim 8, wherein the sweetener is present in an amount of at least about 40% by weight of the confectionery composition.

10. The confectionery composition of claim 9, wherein the sweetener comprises from about 40% to about 80% by weight of the confectionery composition.

11. A process for the preparation of a high brix confectionery comprising the step of depositing the confectionery composition at a temperature less than about 90° C.; wherein the confectionery composition comprises:
a texturizer comprising a low viscosity iota carrageenan and an additional hydrocolloid; and
a sweetener;
wherein the low viscosity iota carrageenan has a viscosity less than about 30 cP when measured in 1.5% concentration at 75° C.;
and wherein the texturizer provides a gelled texture to the final confectionery product.
